(19) United States
(12) Patent Application Publication
(10) Pub. No.: US 2023/0130930 A1
(43) Pub. Date: Apr. 27, 2023

(54) DISABLING SPATIAL AUDIO PROCESSING

(71) Applicant: Hewlett-Packard Development Company, L.P., Spring, TX (US)

(72) Inventors: Sunil Bharitkar, Palo Alto, CA (US); Andre da Fonte Lopes da Silva, Palo Alto, CA (US); Walter Flores Pereira, Palo Alto, CA (US)

(73) Assignee: Hewlett-Packard Development Company, L.P., Spring, TX (US)

(21) Appl. No.: 17/798,104

(22) PCT Filed: Mar. 13, 2020
(86) PCT No.: PCT/US2020/022590

§ 371 Date: Aug. 8, 2022

(51) Int. Cl. H04R 5/04; G10L 15/18

(52) U.S. Cl. CPC H04R 5/04; G10L 15/18; H04R 2420/05

(57) ABSTRACT

In one example in accordance with the present disclosure, a system is described. The system includes a processor to perform spatial audio processing on a received audio signal and an audio interface to connect an audio output device to a computing device. The system also includes a controller. The controller determines a spatial audio processing capability of the audio output device and disables spatial audio processing on one of the audio output device and the processor based on a determination of the spatial audio processing capability of the audio output device.

### BACKGROUND

An audio output device receives an audio stream and generates an output that can be heard by a user. Examples of audio output devices include a speaker and a headphone jack for use with headphones or earbuds. A user may listen to various types of audio from the audio output device such as music, sound associated with a video, and the voice of another person (e.g., a voice transmitted in real time over a network). In some examples, the audio output device may be implemented in a computing device such as a desktop computer, an all-in-one computer, or a mobile device (e.g., a notebook, a tablet, a mobile phone, etc.).

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a system for disabling spatial audio processing, according to an example of the principles described herein.

FIG. 2 depicts an environment and system for disabling audio processing, according to an example of the principles described herein.

FIG. 3 is a flow chart of a method for disabling spatial audio processing, according to an example of the principles described herein.

FIG. 4 is a diagram of a system for disabling spatial audio processing, according to another example of the principles described herein.

FIG. 5 depicts a non-transitory machine-readable storage medium for disabling spatial audio processing, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Audio output devices generate audio signals which can be heard by a user. Audio output devices may include speakers, headphone jacks, or other devices and may be implemented in, or coupled to, any number of electronic devices. For example, audio output devices may be placed in or coupled to electronic devices such as mobile phones, tablets, desktop computers, laptop computers, televisions, and audio receivers, among others. However, such audio output devices may not accurately replicate the characteristics of a recorded audio. That is, in a natural environment, a user may hear sounds from a variety of different directions such as in front of the user, behind the user, to the side of the user. However, certain audio streams do not capture the directionality or movement of audio signals. Spatial audio processing refers to the processing of an audio signal to replicate or mimic the directionality of sound. For example, an incoming audio stream may be processed such that a user, upon listening to the audio, may perceive the audio as coming from a particular direction. As a specific example, it may be the case that an audio track of a movie includes sound effects, such as a car engine, that are intended to be behind the subject. When watching the movie using headphones where spatial audio processing does not occur, the position of the car engine behind the subject may be lost. However, with spatial audio processing, the audio track may be processed such that a listener watching the movie perceives the car engine noise as being behind them. As such, the spatial audio processing provides an immersive experience where a listener has a 360-degree soundscape.

However, while spatial audio processing may generate a more immersive experience for a user, some characteristics may negatively impact the immersive experience. For example, it may be the case that the audio output device and the computing device to which the audio output device is connected both perform spatial audio processing on a particular audio stream. This can lead to interference which creates undesirable artifacts in the audio output. Put another way, a spatial audio processor on a computing device such as a personal computer may perform spatial audio processing to provide a surround sound experience for a user. However, an audio output device, such as headphones, may also have an embedded signal processor that also performs spatial audio processing to create a 3D sound environment.

The spatial audio processing of the audio track by both devices may result in artifacts in the audio and may otherwise negatively impact the output audio. For example, the processing by the audio output device spatial audio processor may interfere with the computing device spatial audio processor as pre-processing on the computing device is supposed to give specific desired experience on headphones. However, if there is additional processing on headphones, it could generate artifacts due to cross of both. That is, while spatial audio processing has the objective of providing directionality to output audio signals, cascaded processing where multiple devices are executing spatial audio processing operations may destroy the directionality of the audio.

As a specific example where a particular audio track is intended to be spatially processed providing a perceived origin of 30 degrees to the front-left of the listener, the spatial audio processing by both the computing device and the audio output device may destroy this 30 degree front-left perception and make the audio sound as if it came from directly behind the user or all directionality may be lost such that there is no perceived direction of the audio. Such cascaded processing may also introduce auditory artifacts such as echoes and vibrations into the audio stream.

Accordingly, the present specification describes a system to prevent such a cascaded signal processing scenario. Specifically, the present specification describes systems and methods for detecting and disabling cascaded signal processing on audio output devices such as headphones. In one example, the system disables spatial audio processing occurring on the audio output device by 1) instructing the headphone to disable the spatial audio processing or 2) generating an inverse filter that accounts for and cancels any spatial audio processing performed by the audio output device. In another example, if the computing device is not able to disable the headphone’s spatial audio processing operations, the computing device may disable its own spatial audio processing.

In some examples, the system may include a database of audio output devices and their respective spatial audio processing capabilities. The database may also include a database of commands to enable/disable particular audio output device’s spatial audio processors and/or inverse filters to cancel the effects of an audio output device’s spatial processing. The database may be updated periodically using a retrieval system and natural language processing with machine learning techniques to identify audio output devices with spatial audio processing technology.

Specifically, the present specification describes a system. The system includes a processor to perform spatial audio processing on a received audio signal and an audio interface to connect an audio output device to a computing device. The system also includes a controller. The controller determines a spatial audio processing capability of the audio output device and disables spatial audio processing on the audio output device or the processor based on a determination of the spatial audio processing capability of the audio output device.

The present specification also describes a method. According to the method, an audio output device connected to a computing device is identified. Based on an identity of the audio output device, a spatial audio processing capability of the audio output device is determined. Spatial audio processing of the computing device or the audio output device is disabled responsive to a determination of the spatial audio processing capability of the audio output device.

The present specification also describes a non-transitory machine-readable storage medium encoded with instructions executable by a processor. The machine-readable storage medium includes instructions to fetch, from a network, data indicating spatial audio processing capabilities of multiple audio output devices. The machine-readable storage medium also includes instructions to populate a database with a mapping between 1) fetched information regarding spatial audio processing capabilities of multiple audio output devices and 2) device-specific instructions for disabling spatial audio processors of the multiple audio output devices. The machine-readable storage medium also includes instructions to identify an audio output device connected to a computing device and, based on an identity of the audio output device and a database entry associated with the audio output device, disable spatial audio processing on the computing device or the audio output device.

Such systems and methods 1) avoid interference from two spatial audio processors of a single audio signal; 2) provide directionality to audio tracks of an audio signal; and 3) prevents cascaded signal processing without user input.

As used in the present specification and in the appended claims, the term “spatial audio processing” refers to an operation wherein directionality is provided to audio tracks of a received audio signal.

Also as used in the present specification and in the appended claims, the term “audio output device,” refers to any device that converts an electronic representation of an audio stream to an audio output that is perceptible by humans. Examples of such devices include, speakers, ear buds, and headphones.

As used in the present specification and in the appended claims, the terms “controller,” “retrieval system,” and “switch,” may refer to electronic components which may include a processor and memory. The processor may include the hardware architecture to retrieve executable code from the memory and execute the executable code. As specific examples, the controller as described herein may include computer readable storage medium, computer readable storage medium and a processor, an application specific integrated circuit (ASIC), a semiconductor-based microprocessor, a central processing unit (CPU), and a field-programmable gate array (FPGA), and/or other hardware device.

As used in the present specification and in the appended claims, the term “machine-readable storage medium” refers to machine-readable storage medium that may be a tangible device that can retain and store the instructions for use by an instruction execution device. The machine-readable storage medium may be an electronic storage device, a magnetic storage device, an optical storage device, an electromagnetic storage device, a semiconductor storage device, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), and a memory stick.

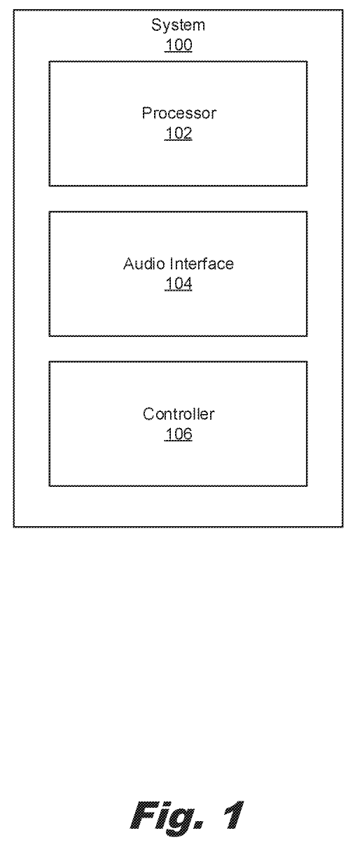

Turning now to the figures, FIG. 1 is a block diagram of a system (100) for disabling spatial audio processing, according to an example of the principles described herein. As described above, the system (100) may be found in a computing device to which an audio output device is connected. Examples of such computing devices include tablets, laptop computers, desktop computers, projectors, smartphones, personal digital assistants, and others. The system (100) may also be presented in other electronic devices such as a television and an audio/video (A/V) receiver.

The system (100) may include a processor (102) to perform spatial audio processing on a received audio signal. That is, the processor (102) may take a stereo audio signal, and provide directionality, such as a point of origin, for the audio. For example, it may the case that a movie or immersive gaming experience has sound information that is intended to be reproduced as if it originated in a 3D space around the listener. Accordingly, the processor (102) takes an audio track that includes this sound information and processes them, for example using head-related transfer functions (HRTFs). An HRTF may be measured using loudspeakers in an anechoic chamber with microphone placed at the entrance. This processing is done such that the sounds are in fact perceived as originating around the user. That is, the audio signals may be processed such that a user’s brain perceives the sound effects as originating behind them. By adding perceived directionality to an audio signal, such spatial audio processing provides a more immersive experience. That is, while a user may be watching a 3D or 2D video, the spatial audio processing which processes audio signals to generate a three-dimensional soundscape gives the perception that the user is immersed in the environment.

The system (100) also include an audio interface (104) through which an audio output device is connected to the computing device in which the system (100) is disposed. For example, in the example where the audio output device is a set of headphones, the audio interface (104) may be an audio jack by which the headphones are physically coupled to the computing device. In another example, the audio interface (104) may be a wireless interface such that audio data is transmitted wirelessly.

The system (100) also includes a controller (106) to alter the spatial audio processing of the audio signal. Specifically, the controller (106) may determine a spatial audio processing capability of the audio output device. This may be done in any number of ways. For example, the controller (106) may include an application programming interface (API) that can detect when an audio output device is connected via the audio interface (104). Via this same API, metadata that identifies the make and model of the audio output device may be determined For example, the metadata may be embedded in a bitstream or in a digital bitstream for universal serial bus (USB) based head-sets or headphones. The API parses the metadata for identification of a type and make of the headphone.

From this make and model information, it may be determined, for example relying on information from a database or retrieved from a network search, whether that make and model are capable of spatial audio processing. That is, upon connection of the audio output device to the computing device, the audio output device may transmit a data packet that includes certain identifying information such as a make and model of an audio output device. Using this information, and other data which may be stored on a database of the system (100) or which may be retrieved remotely, the system (100) may determine whether a particular audio output device has a spatial audio processor and may provide characteristics, protocols, etc. for the spatial audio processing that is performed.

In another example, the metadata itself may identify whether the particular audio output device performs spatial audio processing and may identify the particular spatial audio processing operations carried out by that audio output device. That is, in addition to including the make and model of the audio output device, the metadata may indicate the make and model of a spatial audio processor of the audio output device and/or operating characteristics of a spatial audio processor of the audio output device. Accordingly, from this information, and potentially other information, the controller (106) may determine the full spatial audio processing capabilities of a particular audio output device.

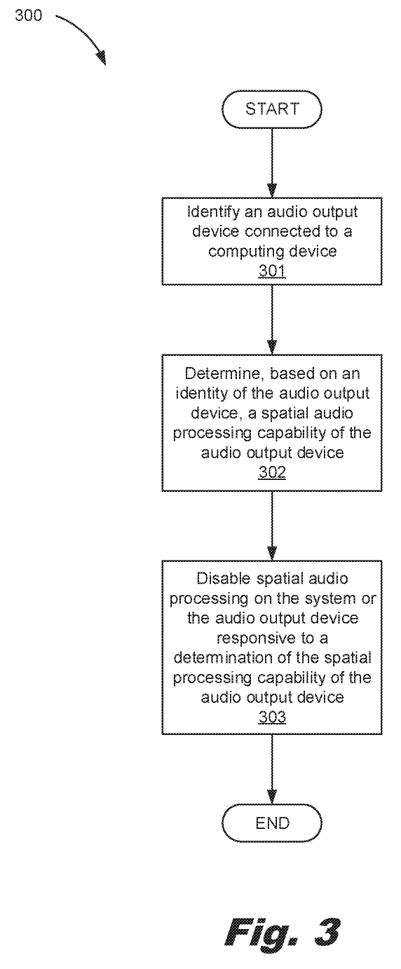

The controller (106) may also disable spatial audio processing on the audio output device or the processor (102) based on a determination of the spatial audio processing capability of the audio output device. That is, once it is determined that an audio output device performs spatial audio processing, the spatial audio processing of the audio output device may be disabled or the spatial audio processing of the processor (102) may be disabled. As will be described below in connection with FIG. 3, there are any number of ways that the spatial audio processing may be disabled.

In the case that the spatial audio processing of the audio output device is disabled, this may include disabling all audio signal processing performed on the audio output device. That is, in addition to performing spatial audio processing, the audio output device may perform other types of signal processing such as equalization which is a function of frequency and gain and pre-compensates the audio output device to generate a flat frequency response. In other examples, disabling the spatial audio processing of the audio output device includes disabling spatial audio processing performed on the audio output device without disabling other audio signal processing performed by the audio output device. For example, such equalization, and other, signal processing operations may be permitted to continue.

In some examples the processor (102) and the controller (106) are separate components. For example, the processor (102) may be a central processing unit (CPU) and the controller may be a digital signal processor (DSP). In other examples, the processor (102) and the controller (106) may be same component, which same component may be the CPU or the DSP.

Accordingly, the present system (100) reduces the effects of cascading signal processing by deactivating either a spatial audio processor of the audio output device or the processor (102) of the system (100). Accordingly, the directionality of the audio tracks is preserved and the aforementioned audio artifacts that result from signal cascading are eliminated.

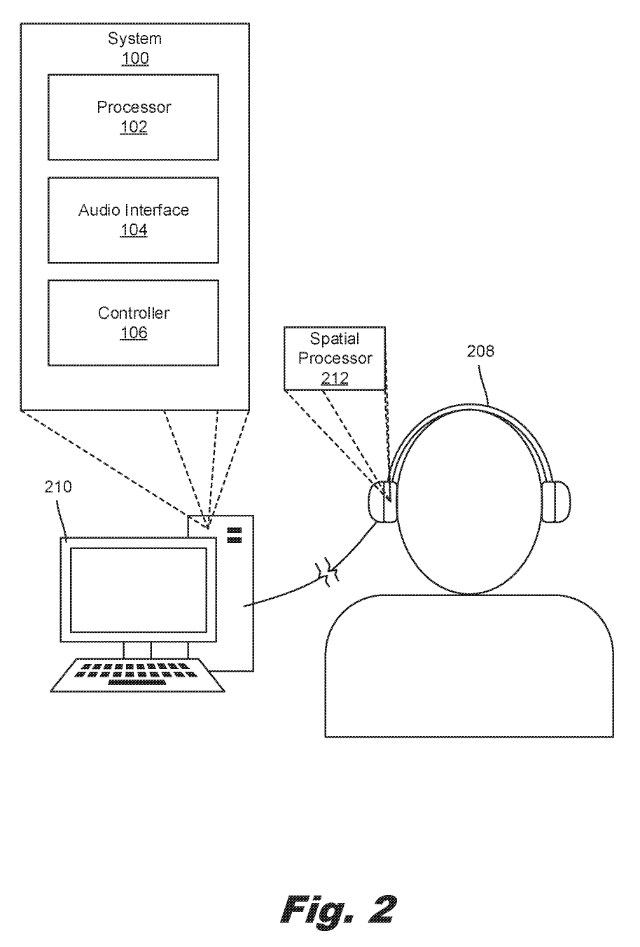

FIG. 2 depicts an environment and system (100) for disabling spatial audio processing, according to an example of the principles described herein. As described above, the system (100) may be disposed on a computing device, which in the example depicted in FIG. 2 is a desktop computer (210). As described above, the system (100) includes a processor (102), audio interface (104), and controller (106).

FIG. 2 also depicts the audio output device (208) which in this example is a pair of headphones donned by a user. As described above, the processor (102) may perform spatial audio processing and a spatial audio processor (212) in the headphones may also perform spatial audio processing. Were both these components allowed to perform their respective spatial audio processing, signal cascading would result which could alter the directionality of certain audio tracks and may introduce undesirable audio artifacts into the output, both of which may lead to a distortion of the original audio and lead to a dissatisfactory listener experience.

FIG. 3 is a flow chart of a method (300) for disabling spatial audio processing, according to an example of the principles described herein. According to the method (300), an audio output device (FIG. 2, 208) that is connected to a computing device (FIG. 2, 210) is identified (block 301). Such an identification (block 301) may occur in any number of ways. For example, responsive to attachment of an audio output device (FIG. 2, 208), the system (FIG. 1, 100) may generate a prompt wherein a user can enter the make and model of the audio output device (FIG. 2, 208) to which the computing device (FIG. 2, 210) is connected. In another example, identifying (block 301) an audio output device (FIG. 2, 208) connected to the computing device (FIG. 2, 210) includes identifying the audio output device (FIG. 2, 208) via metadata received when the audio output device (FIG. 2, 208) is connected to the computing device.

That is, the controller (FIG. 1, 106) may include an application program interface (API) that receives metadata transmitted from the audio output device (FIG. 2, 208). For example, a manufacturer of the audio output device (FIG. 2, 208) may store in the hardware certain metadata that identifies the audio output device (FIG. 2, 208). Upon connection, the API of the controller (FIG. 1, 106) may extract this identifying metadata. For example, the metadata may indicate a make and model of the audio output device (FIG. 2, 208). In a particular example, the identification process starts with the computing device (FIG. 2, 210) subscribing to audio communication devices added, removed, updated to the system. After the computing device (FIG. 2, 210) gets a notification that an audio output device (FIG. 2, 208) was added/updated, the controller (FIG. 1, 106) may, based on the audio output device (FIG. 2, 208) address, retrieve the identification information about the audio output device (FIG. 2, 208) from a local database.

With the connected audio output device (FIG. 2, 208) identified (block 301), it is determined (block 302), based on this identity, what is the spatial audio processing capability of the audio output device (FIG. 2, 208). That is, it may be the case that the audio output device (FIG. 2, 208) does not perform spatial audio processing. Moreover, there are any number of methods, protocols, etc. for performing spatial audio processing, with different audio output devices (FIG. 2, 208) utilizing different protocols and/or methods.

In some examples, determining (block 302) the spatial audio processing capability of the audio output device (FIG. 2, 208), like the identification (block 301), may be based on metadata received when the audio output device (FIG. 2, 208) is connected to the computing device (FIG. 2, 210). For example, it may be the case that the metadata extracted by the controller (FIG. 1, 106) specifies whether or not the audio output device (FIG. 2, 208) performs spatial audio processing and may indicate the specific operations carried out. Accordingly, the spatial audio processing capabilities of the audio output device (FIG. 2, 208) may be extracted directly from the audio output device (FIG. 2, 208).

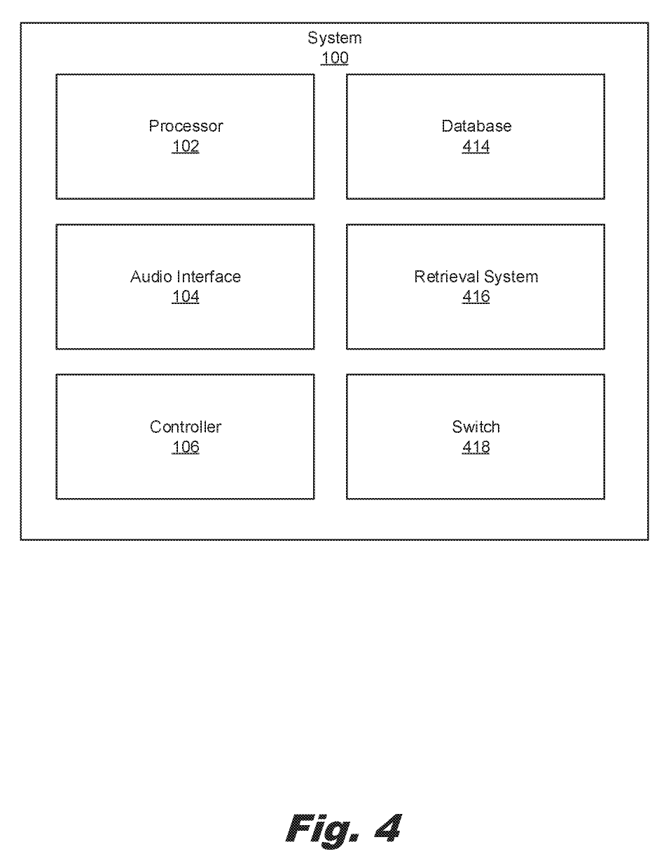

In another example, the determination (block 302) is made based on the identity of the audio output device (FIG. 2, 208). That is, as described above, the metadata or user input, may identify, for example via make and model, a particular audio output device (FIG. 2, 208). In this example, the system (100) may consult a database to identify the associated spatial audio processing capability. That is, a database may identify a variety of audio output devices (FIG. 2, 208) and may indicate for each audio output device (FIG. 2, 208), whether it performs spatial audio processing and/or the specific protocols and standards used. Additional examples of the database and its population are provided below in connection with FIG. 4.

Responsive to a determination (block 302) of the spatial audio processing capability of the audio output device (FIG. 2, 208), the spatial audio processing of the computing device (FIG. 2, 210) or the audio output device (FIG. 2, 208) is disabled (block 303).

This may take many forms. For example, as described above, the spatial audio processing of the audio output device (FIG. 2, 208) may be disabled. This too may be done in a variety of ways. For example, disabling (block 303) the spatial audio processing of the audio output device (FIG. 2, 208) may include transmitting a command from the computing device (FIG. 2, 210) to the audio output device (FIG. 2, 208) to disable the audio output device (FIG. 2, 208) spatial audio processor (FIG. 2, 212).

That is, the computing device (FIG. 2, 210) and the audio output device (FIG. 2, 208) communicate with one another via a protocol. Accordingly, there may be a command in this protocol that allows the computing device (FIG. 2, 210) to shut down just a part of the audio signal processing, i.e., the spatial audio processing operation, or all of the audio signal processing performed by the audio output device (FIG. 2, 208). As a particular example, certain protocols use attention (AT) commands which are control commands defined to establish and manage a connection between devices, in this case between the computing device (FIG. 2, 210) and the audio output device (FIG. 2, 208). In this example, the computing device (FIG. 2, 210) sends an AT command to disable spatial audio processing on the audio output device (FIG. 2, 208). The audio output device (FIG. 2, 208) may then respond with an “OK” message indicating it is disabling the spatial audio processing. Accordingly, via such a command, the spatial audio processor (FIG. 2, 212) of the audio output device (FIG. 2, 208) may be disabled.

In another example, rather than disabling the spatial audio processor (FIG. 2, 212), disabling (block 303) spatial audio processing on the audio output device (FIG. 2, 208) may include invoking an inverse filter to cancel the spatial audio processing performed by the audio output device (FIG. 2, 208). That is, spatial audio processing includes a series of operations to adjust the frequency, phase, and/or amplitude of audio signals in different ways. Accordingly, an inverse filter performs operations on the audio signal that counter the spatial audio processing performed by the audio output device (FIG. 2, 208) such that any spatial audio processing done by the spatial audio processor (FIG. 2, 212) is indiscernible. Put another way, the inverse filter includes a matrix of filters to generate an identity matrix that when cascaded with the spatial audio processing performed by the audio output device (FIG. 2, 208) nullify the audio processing performed by the spatial audio processor (FIG. 2, 212) of the audio output device (FIG. 2, 208).

During operation, the inverse filters are used in addition to the spatial audio processing of the processor (FIG. 1, 102). Accordingly, the inverse filter will cancel out spatial audio processing of the audio output device (FIG. 2, 208) while the spatial audio processing by the processor (FIG. 1, 102) is passed through to generate the desired audio signal directionality.

To generate the inverse filter, the output of an audio output device (FIG. 2, 208) may be measured with nearfield microphones near the audio output device (FIG. 2, 208). A test signal may be passed to the audio output device (FIG. 2, 208) and an impulse response out of the audio output device (FIG. 2, 208) may be captured. These impulse responses account for the spatial audio processing performed by the audio output devices (FIG. 2, 208).

In some examples this may be done by supplying a log-sweep signal to each of the two input channels of the spatial audio processor (FIG. 2, 212) of the audio output device (FIG. 2, 208) and measuring the output response (filters are obtained by dividing the fast Fourier transform (FFT) output with the FFT of the log-sweep). Inverse filters are then created based on the impulse responses to pre-compensate the spatial audio processing from the spatial audio processor (FIG. 2, 212) on the audio output device (FIG. 2, 208). Accordingly, the relevant inverse filter for the audio output device (FIG. 2, 208) may be convolved with the spatial filters of the processor (FIG. 1, 102) when the audio output device (FIG. 2, 208) is detected as being connected to the computing device (FIG. 2, 210).

In yet another example, disabling (block 303) spatial audio processing includes bypassing a spatial audio processing of the computing device (FIG. 2, 210), and more specifically of the system (FIG. 1, 100) disposed on the computing device (FIG. 2, 210). That is, the system (FIG. 1, 100) includes a processor (FIG. 1, 102) that performs spatial audio processing. This processor (FIG. 1, 102), or the spatial audio processing operations of this processor (FIG. 1, 102) may be bypassed. In a particular example, bypassing the spatial audio processing of the computing device (FIG. 2, 210), and more particularly of the system (FIG. 1, 100), may occur when either 1) there is no identified command for disabling the spatial audio processor (FIG. 2, 212) of the audio output device (FIG. 2, 208) or 2) there is no inverse filter identified to cancel out the spatial audio processing performed by the audio output device (FIG. 2, 208).

That is, if the system (FIG. 1, 100) does not identify the audio output device (FIG. 2, 208), there is no inverse filter, there is no effective inverse filter, and/or there is no command that can disable the audio output device (FIG. 2, 208) spatial audio processor (FIG. 2, 212), the system (FIG. 1, 100) spatial audio processing may be disabled. In some examples, bypassing the spatial audio processing of the system (FIG. 1, 100) may be implemented in program code that bypasses spatial audio processing program code. In another example, a mechanical switch may be included in the system (FIG. 1, 100) that bypasses the processor (FIG. 1, 102). Accordingly, the present method disables one of the processing pipelines (i.e., spatial audio processing on the audio output device (FIG. 2, 208) or spatial audio processing on the system (FIG. 1, 100) of the computing device (FIG. 2, 210)) to avoid the cascaded signal processing and resultant audio distortion and/or artifacts.

FIG. 4 is a diagram of a system (100) for disabling spatial audio processing, according to another example of the principles described herein. The system (100) may include a processor (102), audio interface (104), and controller (106) as described in connection with FIG. 1. The system (100) may also include other components. For example, the system (100) may include a database (414) that has entries for multiple audio output devices (FIG. 2, 208). That is, there are any number of audio output devices (FIG. 2, 208) each with different spatial audio processing capabilities. The database (414) generates a mapping between audio output devices (FIG. 2, 208) and the respective spatial audio processing capabilities. That is, each entry in the database (414) includes a mapping between the respective audio output device (FIG. 2, 208) and its respective spatial audio processing capability. For example, the database may identify audio output devices (FIG. 2, 208) by its make and model and for each make and model may identify what spatial audio processing capabilities have been identified and associated with that particular make and model. As will be described below in connection with the retrieval system (416), this database (414) may be continually populated and updated such that the information contained within the database (414) is accurate.

The database (414) may include other mappings. For example, the database (414) may include a mapping between 1) each identified audio output device (FIG. 2, 208), 2), its spatial audio processing capability and 3) an identification of an inverse filter to cancel out spatial audio processing performed by the respective audio output device (FIG. 2, 208) or a command to disable the spatial audio processor (FIG. 2, 212) of the respective audio output device (FIG. 2, 208). That is, the system (100) may include a continuously maintained database (414) of audio output device (FIG. 2, 208) brands and models that perform spatial audio processing and indicates how the spatial audio processing is to be disabled for the associated audio output devices (FIG. 2, 208).

Accordingly, when the system (100), and more specifically the controller (106), determines the identity of the audio output device (FIG. 2, 208), for example via transmitted metadata or user input, a match in the database (414) is made such that appropriate disabling measures may be taken, which measures may include invoking an appropriate inverse filter or executing an appropriate disabling command.

The system (100) also includes a retrieval system (416) to fetch data from a network regarding spatial audio processing capabilities of multiple audio output devices (FIG. 2, 208). That is, the retrieval system (416) may populate the database (414) with the spatial audio processing capabilities. This may occur in any number of ways. For example, the retrieval system (416) may include a machine-learning natural language processor to identify audio output devices (FIG. 2, 208) with spatial audio processing capabilities by keyword searching resources of the network. That is, as described above, the controller (106) may acquire certain identifying information for an audio output device (FIG. 2, 208) such as a pair of headphones. Using this information, the retrieval system (416) may for example, crawl through any number of websites to identify keywords and textual phrases related to spatial audio processing, for example by referring to standards that guide spatial audio processing, trademarks or tradenames referring to spatial audio processing technologies, etc. Accordingly, the retrieval system (416) may populate the database (414) such that appropriate inverse filters and/or commands can be acquired or generated to disable the spatial audio processing on a particular audio output device (FIG. 2, 208).

In some examples, a host computing device (FIG. 2, 210) periodically initiates such a retrieval system (416), which may be a web crawler engine, to fetch pages and use natural language processing (NLP) with machine learning to filter headphone manufacturers brand with mentions of spatial audio processing, etc. and updates and adds entries to the database (414).

In another example, instead of periodically initiating the retrieval system (416), a hosted service may continuously crawl webpages updating the database (414) with the most up-to-date information about audio output devices (FIG. 2, 208) and serving this data as a service. Accordingly, a host computing device (FIG. 2, 210) may download the information without performing the web crawling itself, thus saving processing and other resources of the host computing device (FIG. 2, 210).

The system (100) may also include a switch (418) to bypass the processor (102) of the system (100). That is, as described above in some examples the spatial audio processor (FIG. 2, 212) of the audio output device (FIG. 2, 208) is disabled. In other examples, the processor (102) of the system (100), which processor (102) does the spatial audio processing, is disabled. This may be done by a switch (418), which may be either a program code switch or a mechanical switch. For example, a mechanical switch may bypass the physical processor (102) of the system (100) that performs spatial audio processing. In the example of program code, the program code switch (418) may instructionally disable the operation of the processor (102) to perform the spatial audio processing.

Such a bypass of the processor (102) may occur when disabling of the spatial audio processor (FIG. 2, 212) of the audio output device (FIG. 2, 208) is not supported. For example, the system (100) may determine that the audio output device (FIG. 2, 208) has spatial audio processing capabilities and may determine that disabling the audio output device (FIG. 2, 208) is unsupported. That is, there may not be a suitable inverse filter for the spatial audio processor (FIG. 2, 212) or an inverse filter for the spatial audio processor (FIG. 2, 212) is ineffective, meaning it may not adequately cancel out the spatial audio processing of the spatial audio processor (FIG. 2, 212) or otherwise is ineffective. As yet another example, the controller (106) may determine that no command exists to disable the spatial audio processor (FIG. 2, 212) of the audio output device (FIG. 2, 212) If each of the aforementioned mechanisms to disable the audio output device (FIG. 2, 212) are undesirable due to either not working or not existing, the switch (418) may disable the processor (102) of the system (100) by either physically bypassing the processor (102) or programmatically disabling some portion of the operation of the processor (102) to spatially process an audio signal.

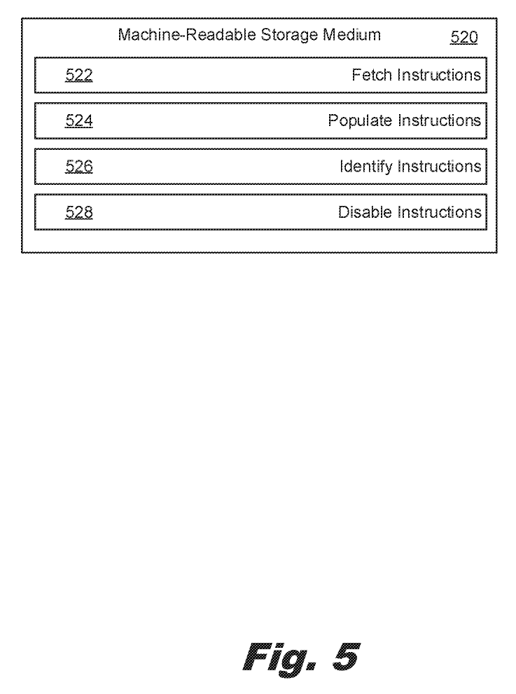

FIG. 5 depicts a non-transitory machine-readable storage medium (520) for disabling spatial audio processing, according to an example of the principles described herein. To achieve its desired functionality, a computing system includes various hardware components. Specifically, a computing system includes a processor and a machine-readable storage medium (520). The machine-readable storage medium (520) is communicatively coupled to the processor. The machine-readable storage medium (520) includes a number of instructions (522, 524, 526, 528) for performing a designated function. The machine-readable storage medium (520) causes the processor to execute the designated function of the instructions (522, 524, 526, 528).

Referring to FIG. 5, fetch instructions (522), when executed by the processor, cause the processor to fetch, from a network, data indicating spatial audio processing capabilities of multiple audio output devices (FIG. 2, 208). Populate instructions (524), when executed by the processor, may cause the processor to, populate a database (FIG. 4, 414) with a mapping between fetched information regarding spatial audio processing capabilities of multiple audio output devices (FIG. 2, 208) and device-specific instructions for disabling a respective audio output device (FIG. 2, 208). Identify instructions (526), when executed by the processor, may cause the processor to, identify an audio output device (FIG. 2, 208) connected to a computing device (FIG. 2, 210). Disable instructions (528), when executed by the processor, may cause the processor to, based on an identify of the audio output device (FIG. 2, 208) and a database (FIG. 4, 414) entry associated with the audio output device (FIG. 2, 208), disable spatial audio processing on one of the computing device (FIG. 2, 210) and the audio output device (FIG. 2, 208).

Such systems and methods 1) avoid interference from two spatial audio processors of a single audio signal; 2) provide directionality to audio tracks of an audio signal; and 3) prevents cascaded signal processing without user input.

What is claimed is:

1. A system, comprising:
a processor to perform spatial audio processing on a received audio signal;
an audio interface to connect an audio output device to a computing device; and
a controller to:
determine a spatial audio processing capability of the audio output device; and
disable spatial audio processing on one of the audio output device and the processor based on a determination of the spatial audio processing capability of the audio output device.

2. The system of claim 1, further comprising a database that comprises entries for multiple audio output devices, wherein each entry comprises:
a mapping between:
a respective audio output device;
its respective spatial audio processing capability; and
a component selected from the group consisting of:
an identification of an inverse filter to cancel out spatial audio processing performed by the respective audio output device; and
a command to disable a spatial audio processor of the respective audio output device.

3. The system of claim 1, further comprising a retrieval system to fetch data from a network regarding spatial audio processing capabilities of audio output devices.

4. The system of claim 3, wherein the retrieval system comprises a machine-learning natural language processor to identify audio output devices with spatial audio processing capabilities by keyword searching resources of the network.

5. The system of claim 1, further comprising a switch to bypass the processor of the system responsive to:
a determination that the audio output device has spatial audio processing capabilities; and
a determination that disabling an audio output device spatial audio processor is unsupported.

6. A method, comprising:
identifying an audio output device connected to a computing device;
determining, based on an identity of the audio output device, a spatial audio processing capability of the audio output device; and
disabling spatial audio processing on one of the computing device and the audio output device responsive to a determination of the spatial audio processing capability of the audio output device.

7. The method of claim 6, wherein disabling spatial audio processing comprises invoking an inverse filter to cancel the spatial audio processing performed by the audio output device.

8. The method of claim 6, wherein disabling spatial audio processing comprises transmitting a command from the computing device to the audio output device to disable a spatial audio processor of the audio output device.

9. The method of claim 6, wherein disabling spatial audio processing comprises bypassing a spatial audio processing performed by the computing device.

10. The method of claim 9, wherein bypassing the spatial audio processing performed by the computing device occurs when at least one of:
no command is identified for disabling a spatial audio processor of the audio output device; and
no inverse filter is identified to cancel out the spatial audio processing performed by the audio output device.

11. The method of claim 6, wherein identifying an audio output device connected to the computing device comprises identifying the audio output device via metadata received when the audio output device is connected to the computing device.

12. The method of claim 6, wherein determining a spatial audio processing capability of the audio output device comprises determining the spatial audio processing capability via metadata received when the audio output device is connected to the computing device.

13. A non-transitory machine-readable storage medium encoded with instructions executable by a processor, the machine-readable storage medium comprising instructions to:
fetch, from a network, data indicating spatial audio processing capabilities of multiple audio output devices;
populate a database with a mapping between:
fetched information regarding spatial audio processing capabilities of multiple audio output devices; and
device-specific instructions for disabling spatial audio processors of the multiple audio output devices;
identify an audio output device connected to a computing device; and
based on an identity of the audio output device and a database entry associated with the audio output device, disable spatial audio processing on one of the computing device and the audio output device.

14. The non-transitory machine-readable storage medium of claim 13, wherein disabling spatial audio processing of the audio output device comprises disabling all audio signal processing performed on the audio output device.

15. The non-transitory machine-readable storage medium of claim 13, wherein disabling spatial audio processing of the audio output device comprises disabling spatial audio processing performed on the audio output device without disabling other audio signal processing performed on the audio output device.
